(19) United States
(12) Patent Application Publication
(10) Pub. No.: US 2024/0336438 A1
(43) Pub. Date: Oct. 10, 2024

(54) ORDER-PICKING VEHICLE EQUIPPED WITH A SINGLE MOTOR FOR DRIVING THE DRIVE WHEELS

(71) Applicant: EXOTEC, CROIX (FR)

(72) Inventors: Marc CHATAIN, ZIMMERBACH (FR); Pierre ROELS, LOMME (FR)

(73) Assignee: EXOTEC, CROIX (FR)

(21) Appl. No.: 18/580,839

(22) PCT Filed: Jun. 9, 2022
(86) PCT No.: PCT/EP2022/065686

§ 371 Date: Jan. 19, 2024

(30) Foreign Application Priority Data
Jul. 21, 2021 (FR) FR2107848

(51) Int. Cl. B65G 1/137; B60K 17/30; B65G 1/06

(52) U.S. Cl. CPC B65G 1/1378; B60K 17/303; B65G 1/065

(57) ABSTRACT

A motorized vehicle intended to transport a load including at least 3 wheels for running along the floor, capable of pivoting at least 90°, the wheels being mounted on pivoting and driving devices attached to the chassis of the vehicle, each of the pivoting and driving devices including a motor for pivoting a wheel about a vertical axis, intended to make it possible to pivot a wheel about itself. A single motor for driving in rotation the wheels intended to actuate the mechanism for driving in rotation the wheels housed in the pivoting and driving devices.

### 1. FIELD OF THE INVENTION

The field of the invention is that of warehouse logistics and in particular of the transport of parts or products.

More specifically, the invention relates to a motorised vehicle intended to transport a load.

The invention particularly applies to the automation of flows of goods of a storage warehouse, for example in an order picking warehouse of a logistics chain, or to the automation of a collection point order delivery service, commonly known as “drive”.

### 2. PRIOR ART

In the overall logistics chain, the management of flows and the handling of products within a warehouse play a key role.

Traditionally, an order picker moves about the warehouse to collect each product of an order at its location on a shelf of a shelving unit.

It is noted that such an organisation implies that the picker travels long distances throughout a working day, which causes fatigue and loss of time when the route is not optimised.

Another drawback is that the picker must know the arrangement of the warehouse perfectly so as not to lose time.

To limit fatigue due to movements, improve the management of the picking, reduce the time for picking orders and its cost, an organisation of warehouses has been invented where the products are collected from the shelving units or by robots then carried by these same robots to order picking stations.

In particular, it has been proposed to implement automatic guided vehicles that are able to both run along the floor and climb along the shelving units to go and collect products stored in containers.

Thus, it is known, for example, from document WO 2010/100513 A2 an automatic guided vehicle equipped on the sides of its chassis with retractable toothed wheels that can be deployed laterally. These toothed wheels are intended to engage on vertical racks attached to shelving units, to enable the vehicle to rise between two shelving units in order to reach the level of a container to be collected.

In order to guide these vehicles along the floor and particularly between the shelving units, it was thought to install circulation rails on the floor. However, the installation of rails is expensive and the presence of rails makes it more difficult to clean the floor. It has also been considered to run automatic guided vehicles directly along the floor between the shelving units and sometimes also even under the shelving units.

In order to be able to control the changes in direction of the vehicle without losing time to go around bends, it was proposed to mount each of the drive wheels of these vehicles on an independent motorised pivoting turret. These known turrets are each equipped with a motor to pivot the wheel about a vertical axis and with a motor to drive the wheel in rotation, to control the movement of the wheels at each instant.

One drawback of these known techniques is that they are complex and expensive to implement, particularly due to the fact that two motors are necessary for each turret.

### 3. OBJECTS OF THE INVENTION

Therefore, the object of the invention is particularly to mitigate the drawbacks of the aforementioned prior art.

More specifically, the object of the invention is to provide a motorised vehicle technique that is easy to implement.

Another object of the invention is to provide a motorised vehicle technique that is not very expensive.

Another object of the invention is to provide a motorised vehicle technique that is reliable.

### 4. DISCLOSURE OF THE INVENTION

These objects, as well as others that will become apparent hereinafter are achieved using a motorised vehicle intended to transport a load comprising at least 3 drive wheels intended to run along the floor, capable of pivoting at least 90°, said drive wheels being mounted on pivoting and driving devices attached to the chassis of the vehicle, each of the pivoting and driving devices comprising a motor for actuating means for pivoting a drive wheel about a vertical axis, intended to make it possible to pivot a drive wheel about itself.

According to the invention, such a vehicle comprises a single motor for driving in rotation said drive wheels intended to actuate the means for driving in rotation said drive wheels housed in said pivoting and driving devices.

Thus in a novel way, the invention proposes to implement a vehicle equipped with a single motor for driving all of the drive wheels of the vehicle, which makes it possible to simplify the implementation of the vehicle and to make it lighter.

This cleverly enables the vehicle to change direction and set off at a right angle and thus travel along an ordered route following the plan of a grid. Indeed, the inventors noted that when the vehicle is envisaged to only move in perpendicular directions, the implementation of a single drive motor, which drives the wheels substantially at the same speed, is sufficient for correcting the small deviations of angular positions of the wheels in relation to these directions of movement. Thus, there is no drift of the vehicle.

In a particular embodiment of the invention, said vehicle is an automatic guided vehicle.

According to a particular embodiment of the invention, said means for pivoting a drive wheel comprise a first toothed wheel driven in rotation by one of said motors for actuating the pivoting means engaged with a second toothed wheel of vertical axis, said second toothed wheel being attached to a fork straddling said drive wheel, the axle of said drive wheel being mounted pivoting in relation to the blade of said fork extending on either side of said drive wheel.

Preferably, said driving means comprise a first conical pinion and a second conical pinion arranged relative to one another so as to form an angular transmission, the axle of said first pinion being coaxial with that of said second toothed wheel and the axle of the second pinion being coaxial with the axle of one of said drive wheels.

In an advantageous embodiment of the invention, said drive motor actuates said means for driving in rotation said drive wheels of each of said pivoting and driving devices by means of a belt.

Preferably, said pivoting and driving devices are substantially identical.

According to a particular embodiment of the invention, a motorised vehicle such as described above has four drive wheels mounted on pivoting and driving devices attached substantially to the four corners of said chassis.

In a particular embodiment of the invention, at least one of said pivoting and driving devices is configured so that the axle of the second pinion of this device passes through the centre of the drive wheel mounted on this device.

The drive wheel then does not turn during its pivoting about a vertical axis.

### 5. LIST OF FIGURES

Other features and advantages of the invention will become more apparent upon reading the following description of one embodiment of the invention, given by way of simple illustrative and non-limiting example, and the appended figures, wherein:

FIG. 1 is a schematic view, in perspective, of an order picking warehouse equipped with an example of embodiment of automatic guided vehicles according to the invention;

FIG. 2 is a detailed representation of one of the vehicles presented with reference to FIG. 1;

FIG. 3 is a detail view, from the top, of the system for driving the drive wheels of the vehicle presented with reference to FIG. 2.

### 6. DETAILED DESCRIPTION OF THE INVENTION

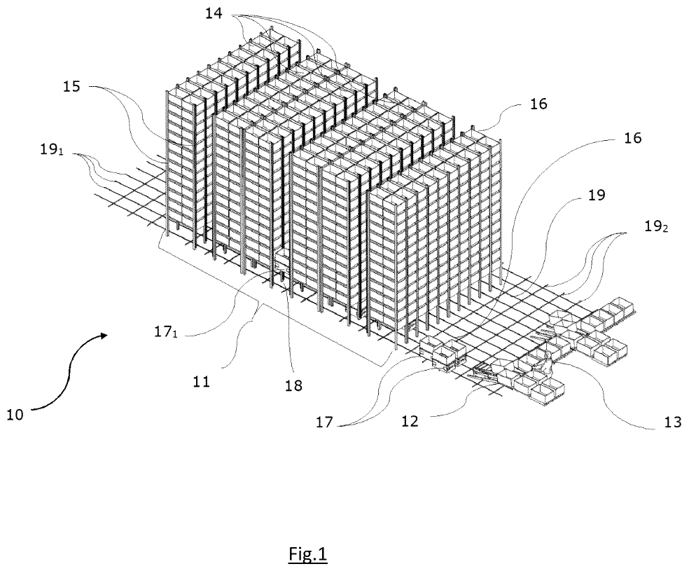

FIG. 1 illustrates a warehouse 10 intended to store products in view of their shipping. This warehouse is divided between a storage area 11 and an order picking area wherein order picking stations 12 are disposed at which operators 13 prepare parcels with the products of an order.

The storage area 11 is organised into shelving units 14 comprising shelves on a plurality of levels supported by posts 15, whereon containers 16 that contain the stored products or items are placed.

A fleet of automatic guided vehicles 17 ensures the transport of the containers 16 between the storage area 11 and the order picking stations 12.

When a robot 17 receives location information for a container 16 containing one or more items to go and collect in order to complete an order processed by an operator 13, the robot 17 runs along the floor up to the bottom of the shelving unit 14 where the container 16 is stored and positions itself in the aisle 18 between this shelving unit 14 and the shelving unit facing it.

During this movement, the robot 17 follows the direction of the lines marked on the floor organised according to the diagram of a grid 19. As can be seen in FIG. 1, a robot 17 can thus move in the direction of the longitudinal lines 19₁ or of the lateral lines 19₂ perpendicular to the lines 19₁ and can circulate under the shelving units 14. This robot 17 subsequently climbs, in the manner of the robot 17₁ shown in FIG. 1, by bearing on two shelving units up to the shelf where the container 16 is stored and removes it from the shelving unit. It subsequently goes back down between the two shelving units, and once on the floor, transports the container 16 to the order picking station 12 by travelling along the grid 19. The operator 13 simply takes the quantity of items ordered and packages them.

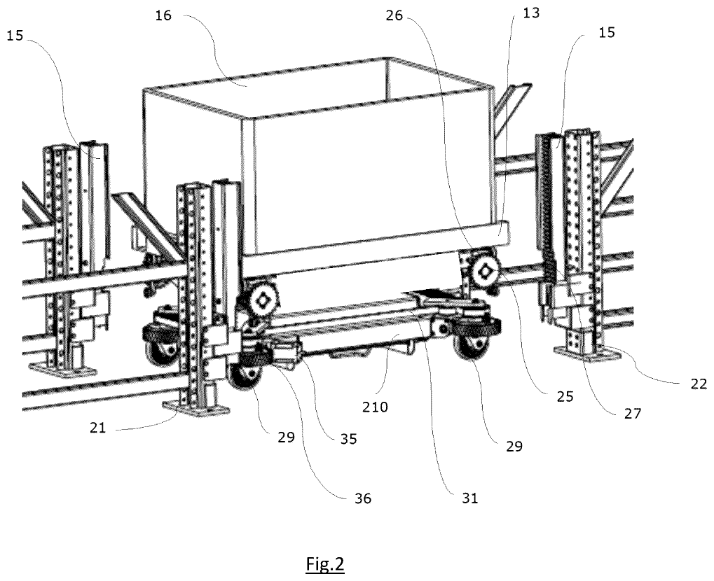

FIG. 2 shows a robot 17 carrying a container 16 in an aisle 18 at the bottom of two shelving units 21 and 22. In this particular embodiment of the invention, the width of the chassis 23 of the robot and that of the container 16 are advantageously smaller than the space between the two adjacent posts 15 of the shelving unit 21 or of the shelving unit 22 in order to enable the robot to pass between these posts.

The robot 17 is equipped at the four corners of its chassis 23 with motorised retractable toothed wheels 25 that can be retracted inside the chassis 23 or deployed outside of the chassis 23.

To climb between the two shelving units 22 and 23, the robot 17 deploys the motorised arms 26 carrying the toothed wheels 25 outside of the chassis 23 in the extension of the diagonals of the chassis until the toothed wheels reach racks 27 attached to the posts 15, as can be seen in FIG. 2, and can engage with the latter.

Moreover, the robot 17 has four drive wheels 29 mounted on turrets at the four corners of the chassis 23 and driven by a single motor 210.

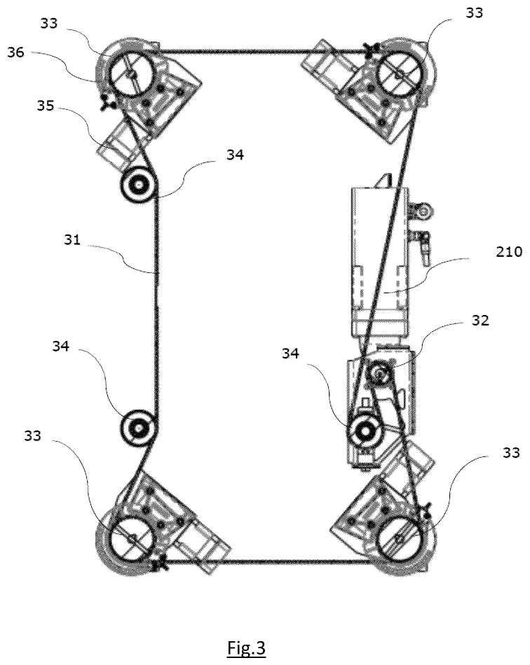

As can be seen in FIG. 3, which is a partial top view of the system for driving the drive wheels 29, the motor 210 drives a toothed belt 31, via a roller 32 coupled to the drive shaft. This belt 31 is held taut using three tensioner rollers 34.

The motion of the belt 31 drives in rotation pulleys 33 connected to the drive wheels 29 by means of two pinions forming an angular transmission.

The rotation of a pulley 33 rotates a first pinion that is attached to and coaxial with this pulley, which engages a second perpendicularly orientated pinion, attached to one end of the axle of the wheel, which drives the drive wheel 29 in rotation with a rotational speed proportional to the reduction ratio of the gearing formed of the two pinions.

In this particular embodiment of the invention, the four turrets are identical and the motor 210 drives the four drive wheels 29 in rotation at the same speed. It should be noted that this single motor enables the vehicle to rotate about itself and thus orientate the vehicle perpendicular to its previous direction to enable it to perform a right angle. Moreover, it should be noted that each of the turrets has a system for pivoting the fork whereon a drive wheel is mounted making it possible to orientate the drive wheels in different directions, independently. This pivoting system comprises a stepper motor 35 and a toothed wheel 36 of axis coaxial with that of the pulley 33, actuated by the motor 35 by means of an intermediate pinion mounted on the shaft of the motor 35.

1-8. (canceled)

9. A motorized vehicle intended to transport a load comprising at least 3 drive wheels intended to run along the floor, capable of pivoting at least 90°, said drive wheels being mounted on pivoting and driving devices attached to the chassis of the vehicle, each of the pivoting and driving devices comprising a motor for actuating means for pivoting a drive wheel about a vertical axis, intended to make it possible to pivot a drive wheel about itself, and
a single motor for driving in rotation said drive wheels intended to actuate the means for driving in rotation said drive wheels housed in said pivoting and driving devices.

10. The vehicle according to claim 9, characterised in that said vehicle is an automatic guided vehicle.

11. The vehicle according to claim 9, wherein said means for pivoting a drive wheel comprise a first toothed wheel driven in rotation by one of said motors for actuating the pivoting means engaged with a second toothed wheel of vertical axis, said second toothed wheel being attached to a fork straddling said wheel, the axle of said drive wheel being mounted pivoting in relation to the blade of said fork extending on either side of said drive wheel.

12. The vehicle according to claim 11, wherein said driving means comprise a first conical pinion and a second conical pinion arranged relative to one another so as to form an angular transmission, the axle of said first pinion being coaxial with that of said second toothed wheel and the axle of the second pinion being coaxial with the axle of one of said drive wheels.

13. The vehicle according to claim 9, wherein said drive motor actuates said means for driving in rotation said drive wheels of each of said pivoting and driving devices by means of a belt.

14. The vehicle according to claim 9, wherein said pivoting and driving devices are substantially identical.

15. The vehicle according to claim 9, further comprising: four drive wheels mounted on pivoting and driving devices attached substantially to the four corners of said chassis.

16. The vehicle according to claim 11, wherein at least one of said pivoting and driving devices is configured so that the axle of the second pinion of this device passes through the centre of the drive wheel mounted on this device.
